(19) United States
(12) Patent Application Publication
(10) Pub. No.: US 2026/0187915 A1
(43) Pub. Date: Jul. 2, 2026

(54) LIDAR-BASED MODEL AND DIGITAL TWIN INTEGRATION

(71) Applicant: INTERNATIONAL BUSINESS MACHINES CORPORATION, Armonk, NY (US)

(72) Inventors: Sarah B. PUGH, Coppell, TX (US); Jennifer M. HATFIELD, Portland, OR (US); Shawn KLIER, Secaucus, NJ (US); Matthew EHN, Westminster, CO (US)

(21) Appl. No.: 19/007,648

(22) Filed: Jan. 2, 2025

(51) Int. Cl. G06T 17/00; G01S 17/89

(52) U.S. Cl. CPC G06T 17/00; G01S 17/89; G06T 2210/56

(57) ABSTRACT

LIDAR data and digital twin integration processes are provided which include generating, by a computing device, a facility digital twin of a product facility that can be accessed in a virtual environment, and obtaining, by the computing device based on data-analytics processing of product-related LIDAR data, a digital product-related model. Further, the process includes linking, by the computing device, the digital product-related model to the facility digital twin for access via the facility digital twin.

### BACKGROUND

One or more aspects relate, in general, to improving processing within a computing environment, and in particular, to improving access to LIDAR-based, product-related models, as well as digital product-related event models.

In general, a digital twin is a virtual model designed to accurately reflect a physical object, and simulate the virtual environment of the physical object. In practice, a digital twin of a physical object can be created using data collected through one or more sensors sensing the object.

Light Detection and Ranging (LIDAR) or Laser Imaging, Detection and Ranging, is a sensing technology that can scan a terrain to determine ranges of objects within the terrain. In operation, a LIDAR device uses a laser and measures the time it takes for reflected light to return to the LIDAR device's sensors. The LIDAR device produces LIDAR point clouds, which are collections of millions of points that represent the location and shape of objects within a scanned area. The points refer to data points that map a particular scanned object or feature using the LIDAR device.

### SUMMARY

Certain shortcomings of the prior art are overcome, and additional advantages are provided herein through the provision of a computer-implemented method which includes generating, by a computing device, a facility digital twin of a product facility that can be accessed in a virtual environment, and obtaining, by the computing device based on data-analytics processing of product-related LIDAR data, a digital product-related model. Further, the computer-implemented method includes linking, by the computing device, the digital product-related model to the facility digital twin for access via the facility digital twin.

Computer program products and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the disclosed inventive aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1A depicts one example of a computing environment to include and/or use one or more aspects of the present disclosure;

FIG. 1B depicts another example of a computing environment to include and/or use one or more aspects of the present disclosure;

FIG. 2 depicts one embodiment of an integration code, in accordance with one or more aspects of the present disclosure;

FIG. 3 depicts one embodiment of an integration process, in accordance with one or more aspects of the present disclosure; and

FIG. 4 depicts a further embodiment of a computing environment to include and/or one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known software, systems, devices, processing techniques, sensors, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative embodiment can be implemented in software, hardware, or a combination thereof.

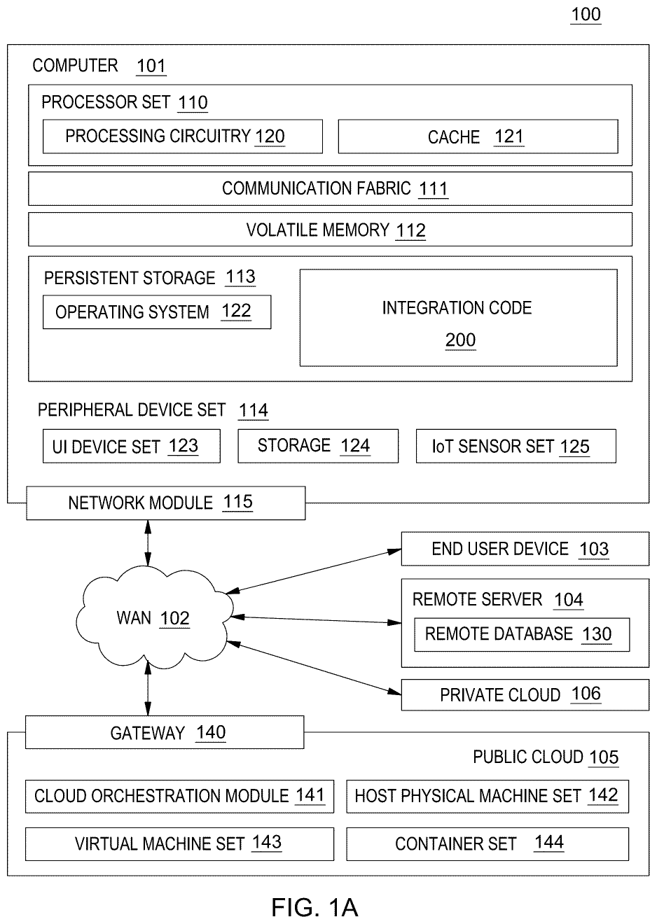

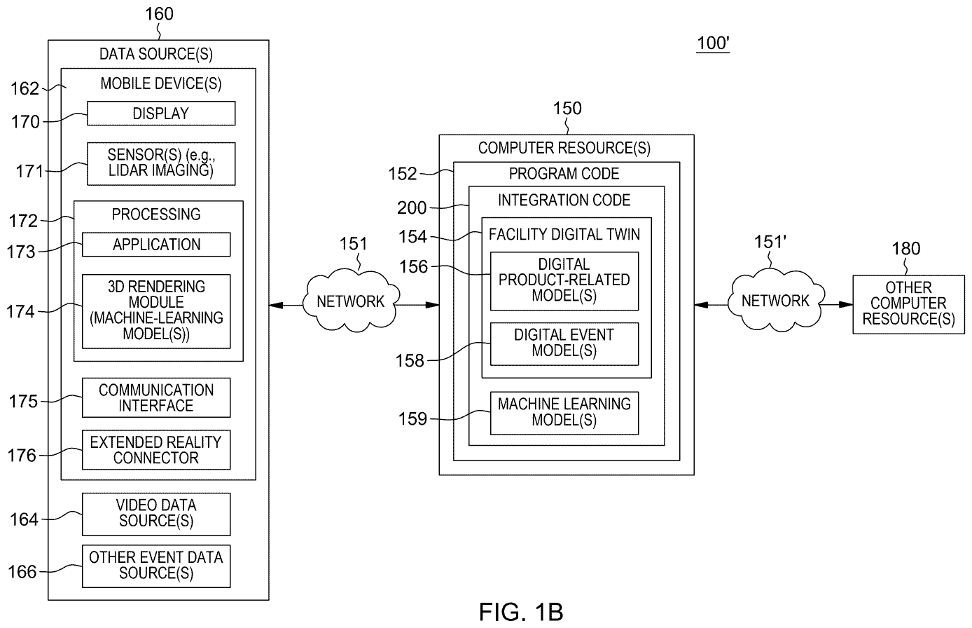

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1A, including operating system 122 and integration code 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1A, computing environment 100 contains an example of an environment for the execution of at least some of the computer code involved in performing the inventive methods, such as integration code 200. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1A. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in data-analytics-based integration code 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1A): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1A need not be included in the computing environment and/or are not used for one or more aspects of the present disclosure. Further, in one or more embodiments, additional and/or other components/modules can be used. Other variations are possible.

By way of further example, FIG. 1B depicts another embodiment of a computing environment 100′, which can incorporate, or implement, one or more aspects of an embodiment of the present disclosure. In one or more embodiments, computing environment 100′ is implemented as part of, or includes, a computing environment such as computing environment 100 described above in connection with FIG. 1A. Computing environment 100′ contains one or more computer resources 150, such as one or more computers 101 of FIG. 1A, connected to receive (e.g., obtain, access, retrieve, etc.) data from one or more data sources 160, such as one or more mobile devices 162, one or more video data sources 164 and/or one or more product-related data sources or product-related event data sources 166, as well as from one or more other computer resources 180, such as one or more computers 101 of FIG. 1A.

In one or more embodiments, mobile device(s) 162 includes an electronic device, such as a smartphone, wireless computer, tablet, personal digital assistant (PDA), laptop computer, etc. In one or more embodiments, mobile device(s) 162 includes components to facilitate implementation of a particular process. For instance, mobile device(s) 162 includes, in one or more embodiments, a display 170 for displaying, for instance, data being captured and/or a 3D rendered model, such as a digital 3D product-related model as described herein. In addition, mobile device(s) 162 includes one or more sensors 171, including one or more LIDAR imaging sensors. The LIDAR sensors produce LIDAR point cloud data, which can be a collection of millions of points that represent, for instance, one or more objects, or features of objects, within a scanned area. The points refer to data points that map within the scanned area a particular object or feature. For instance, in one or more embodiments, sensor(s) 171 of mobile device(s) 162 can scan an object, such as a vehicle or a portion of a vehicle. In one embodiment, vehicle damage resulting from an accident can be scanned via the LIDAR imaging sensor(s) to produce digital product-related LIDAR data representative, at least in part, of the damaged area of the vehicle.

In one or more embodiments, mobile device(s) 162 further includes a processing module or code 172, which can include one or more mobile applications 173 configured to facilitate performing aspects of a process, such as for one or more aspects of the processing embodiments described herein. In one embodiment, processing module 172 further includes a 3D rendering module 174, which can use one or more trained machine learning models to generate or render a digital 3D product-related model from LIDAR point cloud data. For instance, in a vehicle accident implementation, 3D rendering module 174 renders a digital 3D model of the damaged vehicle by data analytics processing of the LIDAR point cloud data. In one or more embodiments, processing module 172 and/or application(s) 173 is configured to process the LIDAR point cloud data in real-time to produce the 3D model rendering of the damaged vehicle. This can involve converting the raw point cloud data into a 3D mesh, applying texture mapping for realistic visualization, and optionally, displaying the rendered 3D image within the application interface on the display 170. In embodiments, the machine learning model(s) used by 3D rendering module 174 is a trained machine learning model for the particular product and/or process implemented, as described herein.

In one or more embodiments, mobile device(s) 162 further includes a communication interface 175 and an extended reality connector 176, depending on the particular process. In one embodiment, communication interface 175 facilitates secure and efficient data upload to, for instance, transfer a 3D model rendering of a product (or feature of a product) to a remote computer resource(s) 150, such as a centralized server and/or cloud-based server. In one or more embodiments, communication interface 175 includes a capability to compress the 3D data to minimize upload times and data usage, and includes error-checking mechanisms to ensure successful upload and encryption for secure data transfer to computer resource(s) 150. In addition, in one or more embodiments, the digital 3D product-related model can be transferred to the computer resource(s) 150 via a secure application programing interface (API) connection.

In one or more embodiments, aspects of the present invention facilitate one or more processes with, for instance, integration of LIDAR, digital twining and extended reality technologies to facilitate processing within a computing environment. As described herein, the digital product-related module 156 is linked via integration code 200 to a facility digital twin for access via the facility digital twin 154. In one or more embodiments, the mobile device(s) 162 and computer resource(s) 150 include communication modules that allow, for instance, extended reality connection or communication 176, which facilitates, for instance, extended reality playback of a digital event model 158 of a product-related event, such as a generated digital event model of a vehicle accident, as disclosed herein.

In embodiments, the one or more computer resources 150 execute program code 152 that implements, for instance, one or more aspects of integration code 200. In one or more embodiments, integration code 200 includes, or generates, a facility digital twin 154 which is a digital twin of a product facility that can be accessed in a virtual environment. For instance, in one or more implementations, the facility digital twin can be a digital twin of a vehicle repair shop, or in another embodiment, a digital twin of a product production line. Many different facility environment digital twins are possible. In one or more embodiments, the digital twin is a virtual environment which can be configured to facilitate processing (within the computing environment) and facilitate interaction between multiple parties relating to a particular product and/or event, such as a vehicle accident. In one or more embodiments, one or more digital product-related models 156 (e.g., 3D rendered model(s)) are linked for access via the facility digital twin 154. In one or more embodiments, one or more generated digital event models 158, such as one or more models generated based on data received from a variety of data sources 160, including, for instance, video data source(s) 164 and/or other event data sources 166, is also linked to the facility digital twin for viewing via the digital twin. In one or more embodiments, integration code 200 can utilize one or more trained machine learning models 159, which can be part of integration code 200 or accessed by integration code 200. For instance, in one or more embodiments, the machine learning model 159 can be used to facilitate generating the one or more digital event models 158, such as described herein.

In embodiments, integration code 200 generates facility digital twin 154 and links the digital product-related model(s) 156 and/or digital event model(s) 158 to the facility digital twin for one or more users to access via, for instance, one or more extended reality technologies. For instance, in one or more embodiments, mobile device(s) 162 and/or other computer resource(s) 180 can operatively couple to computer resource(s) 150 to allow access to facility digital twin 154 across one or more networks 151, 151′ for viewing digital product-related model(s) 156 and/or digital event model(s) 158 using, for instance, an extended reality technology such as virtual reality (VR), augmented reality (AR) or mixed reality (MR). In one or more embodiments, computing environment 100′ can include, or utilize, one or more networks 151, 151′ for interfacing various aspects of computer resource(s) 150, as well mobile device(s) 162 and other computer resource(s) 180, as well as one or more other controllers, components, systems, sensors, devices, computer resources, etc., providing data or accessing data linked or associated with facility digital twin 154 in a manner that facilitates processing within the computing environment for the particular process, such as a particular product-related process. By way of example, the network(s) can be, for instance, a telecommunications network, a local area network (LAN), a wide area network (WAN), such as the Internet, or a combination thereof, and can include wired, wireless, fiber optic connections, etc. The network(s) can include one or more wired and/or wireless networks that are capable of receiving and transmitting data, including training data for one or more artificial intelligence (AI) agents or machine learning models of, or used by, integration code 200, and/or one or more machine learning models of, or used by, 3D rendering module 174 of mobile device(s) 162, in one embodiment.

In one or more implementations, computer resource(s) 150 house and/or execute program code 152 configured to perform computer-implemented methods in accordance with one or more aspects of the present disclosure. By way of example, computer resource(s) 150 can be a computing-system-implemented resource(s). Further, for illustrative purposes only, computing resource(s) 150 in FIG. 1B is depicted as being a single computer resource. This is a non-limiting example of an implementation. In one or more other embodiments, computer resource(s) 150, which implements one or more aspects of processing such as discussed herein, can, at least in part, be implemented in multiple separate computer resources or systems, such as one or more computer resources of a cloud-hosting environment, and/or one or more mobile device(s) 162, or other computing resource(s) 180, by way of example.

Briefly described, in one embodiment, computer resource(s) 150 can include one or more processor sets with one or more processors, for instance, central processing units (CPUs). Also, the processor set(s) can include functional components used in the integration of program code, such as functional components to fetch program code from locations in memory, such as cache or main memory, decode program code, and execute program code, access memory for instruction execution, and write results of the executed instructions or code. The processor set(s) can also include a register(s) to be used by one or more of the functional components. In one or more embodiments, the computing resource(s) can include memory, input/output, a network interface, and storage, which can include and/or access, one or more other computing resources and/or databases, as required to implement the integration code processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computer resource(s), or computing system(s) or controller(s), which can implement one or more aspects disclosed are described further herein.

In one or more embodiments, program code 152, 172 includes, executes, accesses, etc., one or more artificial intelligence agents which (in one or more embodiments) can include training and using one or more machine learning models 159, 174 that embody (in part), or are used by, the integration code 200 and/or 3D rendering module 174. The artificial intelligence agent(s) can be an existing artificial intelligence (AI) agent or existing AI tool and/or can include, or use, one or more machine learning models that can be pretrained using training data that can include, for instance, a variety of types of LIDAR point cloud data, such as a variety of LIDAR point cloud data of damaged vehicles in one embodiment only. For instance, in one or more embodiments, program code 152 executing on one or more computer resources 150 applies one or more algorithms of, for instance, the artificial intelligence agent(s) to generate and train the model(s) 159, which the program code then utilizes to, for instance, implement one or more aspects of integration code 200 and/or 3D rendering module 174. In an initialization or learning stage, program code 152 can train the one or more machine learning models using obtained training data to implement, for instance, one or more aspects of the code, functions, modules and/or tools described herein.

In one or more embodiments, data used to train the models can include a variety of types of LIDAR point cloud data, such as a variety of types of LIDAR image data of damaged vehicles to, for instance, facilitate 3D rendering 172 of a damaged vehicle from LIDAR point cloud data. In another aspect, the one or more machine learning models 159 can be trained to facilitate recreating, for instance, a vehicle-related event, such as a vehicle accident, in three dimensions. Reinforcement learning algorithms can learn from available data to generate a realistic replay of the vehicle-related event. Note in this regard that a variety of libraries are available for machine learning, which provide comprehensive tools for developing and training machine learning models. They can be used to implement the machine learning algorithms required for, for instance, automatic vehicle damage recognition and/or automatic generation of a digital event model of a product-related event, such as a vehicle accident, as described herein.

Program code, in embodiments of the present disclosure, can perform data analysis to generate data structures, including algorithms utilized by the program code to implement one or more aspects of the 3D rendering module or code 172 and/or integration code 200 and/or initiate (or perform) an action related thereto. As known, machine learning-based modeling solves problems that cannot be solved by numerical means alone. In one example, program code extracts features/attributes from the training data, which can be stored in memory or one or more databases. The extracted features can be utilized to develop a predictor function, h(x), also referred to as a hypothesis, which the program code utilizes as a model. In identifying machine learning model(s), various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weigh various attributes (e.g., features, patterns) that correlate to enhanced performance of the model.

In one or more embodiments, program code, executing on one or more processors, utilizes one or more artificial intelligence agents (now known or later developed) to facilitate implementing one or more aspects disclosed herein. In one or more embodiments, the program code can interface with application programming interfaces to perform a cognitive analysis of obtained and/or converted data. Specifically, in one or more embodiments, certain application programing interfaces include a cognitive agent (e.g., learning agent) that includes one or more programs, including, but not limited to, natural language classifiers, a retrieve-and-rank service that can surface the most relevant information, concepts/visual insights, tradeoff analytics, document conversion, and/or relationship extraction. In an embodiment, one or more programs analyze the data obtained by the program code from one or more sources utilizing one or more of a natural language classifier, retrieve-and-rank application programming interfaces, and tradeoff analytics application programing interfaces, etc.

In one or more embodiments, the program code can utilize one or more neural networks (NNs) to analyze training data, such as collected LIDAR data, product-related video data, other product-related data, and/or product-related event data, to generate, for instance, one or more operational machine learning models. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present disclosure, can utilize in implementing a edge controller code optimization, such as described herein.

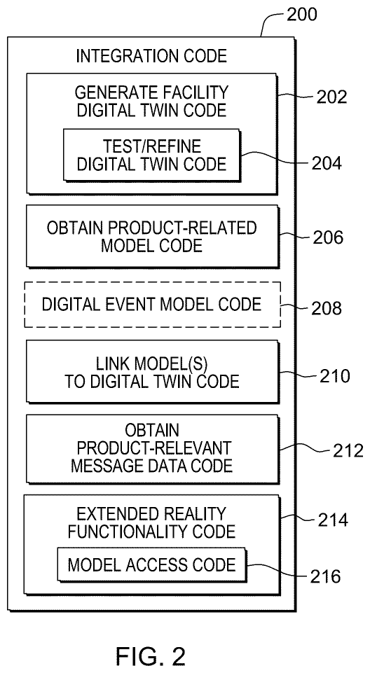

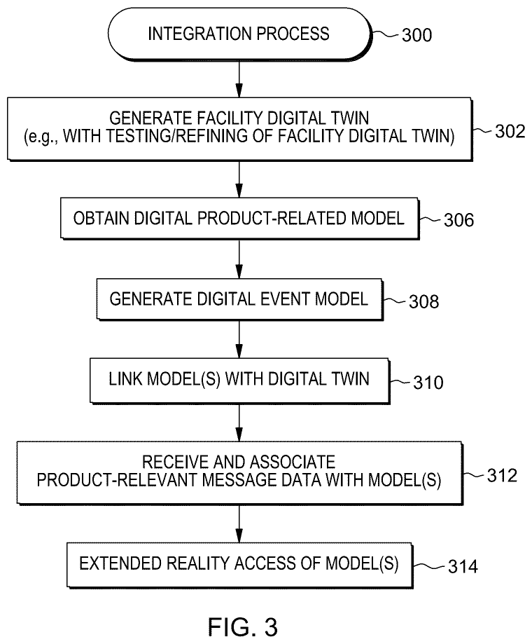

By way of example, one or more embodiments of an integration code and workflow are described initially with reference to FIGS. 2-3. FIG. 2 depicts one embodiment of integration code 200 that includes code or instructions to perform integrated processing, in accordance with one or more aspects of the present disclosure, and FIG. 3 depicts one embodiment of an integration process, in accordance with one or more aspects of the present disclosure.

Referring to FIGS. 1A-2, integration code 200 includes, in one example, various code or sub-modules used to perform processing, in accordance with one or more aspects of the present disclosure. The sub-modules are, e.g., computer-readable program code (e.g., instructions) in computer-readable media (e.g., persistent storage (e.g., persistent storage 113, such as a disk) and/or a cache (e.g., cache 121), as examples). The computer-readable media can be part of a computer program product and can be executed by, and/or using, one or more computing devices (e.g., one or more computers, such as computer(s) 101 (FIG. 1A) and/or computer resource(s) 150 (FIG. 1B) and/or mobile device(s) 162 (FIG. 1B); one or more servers such as remote server(s) 104 (FIG. 1A), one or more processors or nodes, such as processor(s) or node(s) of process set 110 (FIG. 1A); processing circuitry, such as processor circuitry 120 of processor set 110; and/or other computing devices, etc.). Additional and/or other computing devices, computers, servers, processors, nodes and/or processing circuitry can be used to execute the code and/or portions thereof. Many examples are possible.

As noted, FIG. 2 depicts one embodiment of integration code 200 which, in one or more implementations, includes, or facilitates, integration processing in accordance with one or more aspects of the present disclosure. In the embodiment of FIG. 2, example code of integration code 200 includes generate facility digital twin code 202 to generate, by a computing device, a facility digital twin of a product facility that can be accessed in a virtual environment. For instance, in one embodiment, the facility digital twin is developed in the metaverse, and the generating includes creating a realistic 3D virtual model of a facility, such as a repair shop, production line, etc., including one or more of the layout, tools and/or machinery, as desired. Further, the generated digital twin is used, in one or more embodiments, as the virtual environment for assessment of a product, exchanging of messages, etc., and processing related thereto. In one or more embodiments, existing engines for the metaverse environment can be used to provide resources necessary for creating the digital twin of the facility. In one or more embodiments, test/refine digital twin code 204 is associated with, or used by, generate facility digital twin code 202 to, for instance, facilitate testing and refinement of the facility digital twin and/or one or more features described herein associated with or linked to the facility digital twin.

In embodiments, integration code 200 further includes obtain product-related model code 206 to obtain, by the computing device based on data-analytics processing of product-related LIDAR data, a digital product-related model. For instance, in one or more embodiments, the integration code receives (e.g., retrieves, accesses) the digital product-related model from a mobile device(s) 162 (FIG. 1B) that was 3D rendered (e.g., in real-time) from LIDAR point cloud data obtained from LIDAR imaging of the product, such as a damaged vehicle. In one or more embodiments, integration code 200 further optionally includes digital event model code 208 to, for instance, receive (obtain, collect, retrieve, etc.) vehicle-related event data, such as data on a product-related event, such as a vehicle accident. The event data can be obtained, for instance, from one or more video data sources 164 (FIG. 1B), one or more other data event sources 166 (FIG. 1B), such as event-related reports, etc. In an embodiment, one or more machine learning models 159 (FIG. 1B) can facilitate generating one or more digital event models recreating a product-related event in three dimensions. In one embodiment, reinforcement learning algorithms can be used to learn from available product-related data and generate a realistic model for replay of the vehicle-related event.

In embodiments, integration code 200 further includes link model(s) to digital twin code 210 to provide the one or more digital product-related model(s) and/or digital event model(s) for access via the generated facility digital twin, such as described herein. For instance, in embodiments, the facility digital twin in the metaverse is generated and the one or more models 156, 158 (FIG. 1B) are linked to, or associated with, the facility digital twin for viewing within, or in association with, the digital twin of the facility.

In embodiments, integration code 200 includes obtain product-relevant data message code 212. For instance, product-relevant message data can be obtained from one or more mobile devices 162 (FIG. 1B) and/or one or more other computer resources 180 (FIG. 1B) and provided (e.g., linked, integrated, associated, etc.), by the computing device, for access via the facility digital twin. In one or more embodiments, integration code 200 includes extended technology functionality code 214 to allow one or more users to view and interact with the digital twin using virtual reality, artificial reality and/or mixed reality devices. For instance, in the case of a vehicle accident, one or more vehicle body technicians, the vehicle owner, and/or one or more insurance adjusters can interact with the 3D model of the damaged vehicle simultaneously, and leave notes, make annotations, collaborate in real-time within the facility digital twin in the metaverse, thereby facilitating processing within the computing environment. In embodiments, extended reality functionality code 214, includes model access code 216 which facilitates a user's interaction with the facility digital twin, and in particular, the digital product-related model(s) and/or the digital event model(s). For instance, one or more open-source web browsers and/or mobile applications with real-time communication capabilities and simple, applicable communication APIs can be used to support extended reality functionality integration and model access, such as described herein.

Note also that although various code or sub-modules are described herein, an integration code, such as disclosed, can use, or include, additional, fewer, and/or different code/sub-modules. A particular code can include additional code, including code of other sub-modules, or less code. Further, additional and/or fewer code/sub-modules can be used. Many variations are possible.

In one or more embodiments, the integration code is used, in accordance with one or more aspects of the present disclosure, to perform integrated processing. FIG. 3 depicts one example of an integration process 300, such as disclosed herein. The process is executed, in one or more embodiments, by one or more computing devices, such as one or more computers (e.g., computer 101 (FIG. 1A), mobile device 160 (FIG. 1B), computer resource(s) 150 (FIG. 1B)), and/or one or more processor sets, such as a processor or processing circuitry (e.g., of processor set 110 of FIG. 1A). In one example, code or instructions implementing the process, are part of a code or module, such as integration code 200 of FIGS. 1A-2 and/or processing module 172 (FIG. 1B). In other examples, the code can be included in one or more other modules and/or one or more other sub-modules of one or more other modules. Various options are available.

As illustrated in FIGS. 1A-1B & 3, in one example, integration process 300 executing on one or more computers (e.g., computer 101 of FIG. 1A), one or more processor sets (e.g., processor set 110 of FIG. 1A, such as a processor or processing circuitry of the processor set) performs integrated processing such as described herein, which includes, in one or more embodiments generating a facility digital twin 302 of a product facility that can be accessed in a virtual environment. As noted, the process can include testing and refining of the facility digital twin and/or the extended reality metaverse integration thereof, such as described. For instance, in one or more embodiments, any identified issues can be addressed by the computer resource(s) or system, and further be refined based on one or more user's feedback. In one or more embodiments, the virtual environment of the facility digital twin includes the metaverse.

In one or more embodiments, integration process 300 further includes obtaining a digital product-related model 304. For instance, obtaining the digital product-related model can include, receiving (retrieving, obtaining, etc.), a 3D digital product-related model from a mobile device 162 (FIG. 1B), such as a 3D rendering of a product-related model generated from LIDAR point cloud data created from LIDAR imaging of a product. In one or more other embodiments, the LIDAR point cloud data can be transferred, retrieved, etc., by a computer resource(s) 150 (FIG. 1B) executing integration process 300 to generate the digital product-related model(s) as part of the integration process at the computer resource(s), as opposed to at the mobile device(s) 162 (FIG. 1B). Many variations are possible.

In one or more embodiments, integration process 300 includes generating a digital event model 306 of a product-related event, such as a vehicle accident. As noted, the digital event model devices(s) can be generated by the computer resource(s) executing the integration process using data received or obtained from one or more data sources, such as data from one or more mobile devices 162 (FIG. 1B), one or more video data sources 164, and one or more other event-related data sources 166. In embodiments, one or more machine learning models 159 are trained and used to generate the digital 3D event model, which can then be replayed using, for instance, one or more of virtual reality, augmented reality and/or mixed reality technologies.

In embodiments, integration process 300 further includes linking (e.g., associating) the digital product-related model(s) and/or digital event model(s) with the digital twin 308 to allow viewing and/or playback of the models via the facility digital twin. In embodiments, integration process 300 further includes receiving and associating product-relevant message data to the digital product-related model(s) and/or digital event model(s) 310. In this manner, feedback and annotations can be made by technicians, agents, etc., in the metaverse in association with the facility digital twin to be sent back to, for instance, a user's mobile device via a notification or alert system whenever an update or new message is provided within the facility digital twin. Pushing uploaded messages in the facility digital twin to the user's mobile device allows the user to timely respond or otherwise add one or more further annotations if necessary. In embodiments, integration process 300 further includes facilitating extended reality access to the digital product-related model(s) and/or digital event model(s) 312 via the facility digital twin in the metaverse.

As noted, in one or more embodiments, the computer-implemented methods, computer program products and computer systems disclosed herein facilitate integrated processing using the metaverse and LIDAR technology, as well as extended reality technologies. In one or more embodiments, a digital twin of a product facility, such as a vehicle repair shop, is generated in the metaverse to enhance, for instance, processing of one or more claims related to a product-related event, such as a vehicle accident. In accordance with one or more aspects, digital claim processing is embedded or linked with the facility digital twin, and the different technologies are integrated to facilitate processing within the computing environment. In one or more embodiments, the facility digital twin, for instance, of a vehicle repair shop, provides an environment for the relevant parties, (e.g., repair technician, claim agent, insured, etc.) to use virtual reality (VR) or web-based access, and collaborate in the metaverse space, leave messages or notes related to the event, such as an accident, overlaid on the vehicle or associated with the vehicle, and help identify issues sooner to complete processing of claims faster and more accurately. In one or more embodiments, video playback of a generated digital event model, such as a 3D generated model of a vehicle accident, allows the parties involved to view the accident virtually in 3D space, enabling new views, overlaying of statistics (such as weather, camera locations, vehicle speed, speed limits, etc.) and overall be better informed when assigning fault in the case of a vehicle accident. Note that although principally described herein with reference to a vehicle accident, the integrated processing disclosed can be used in a variety of product-related embodiments, with a production line embodiment also being described herein, again by way of example only.

In one or more embodiments, the integration processes disclosed streamline product-related damage identification through the use of LIDAR imaging, virtual reality/augmented reality and the facility digital twin in the metaverse, to allow for real-time 3D virtual video playback by leveraging the capabilities of virtual reality and mixed reality to allow a specialist to be immersed at the scene by being able to recreate the scene or event (e.g., vehicle accident) and play it back as if it were in real-time, allowing one or more individuals to view the accident in 3D space, enabling new views, overlay statistics, etc. Advantageously, leveraging metaverse capabilities and generating a facility digital twin of, for instance, a vehicle repair shop, allows for embedding of digital data at the digital twin, and leveraging the latest technologies. Once a vehicle has been scanned via LIDAR imaging, the 3D image data, or 3D model created from the image data, is uploaded to the digital twin to allow virtual access to the data before the vehicle is even at a repair shop. In this manner, for instance, a vehicle that is a total loss can be identified in an instant virtually.

In one or more embodiments, LIDAR imaging, digital twinning in the metaverse, and extended reality technologies are used in the integration process. In embodiments, many mobile devices, such as smartphones, are now available with LIDAR imaging sensors built into the mobile device. Using such a mobile device, a user scans the product (such as a damaged vehicle) to capture LIDAR point cloud data representative of the product and damage. As noted, a mobile application 173 (FIG. 1B) is provided to assist the user in a step-by-step process. In one or more embodiments, the LIDAR point cloud data is used to render a three dimensional model of the product and/or can be provided to one or more remote computer resource(s) 150 (FIG. 1B) across a network for rendering of the 3D model. By creating a digital twin of the relevant facility, the parties involved in processing a claim, such as an insurance claim, are able to collaborate more efficiently to improve the process. Once a vehicle is scanned by LIDAR imaging, the 3D digital product-related model can be uploaded in real-time to the facility digital twin, reducing the need for a technician to physically have the product in hand in order to initially evaluate the product. In one or more embodiments, the product technicians, claim agents, etc., can leverage virtual reality or web-based access to collaborate in the metaverse space, that is, at the facility digital twin to leave messages on their findings overlayed on the product, and help identify further issues faster and more accurately. Once the product has been brought the facility, such as a vehicle repair shop, the repair technician can leverage, in one embodiment, augmented reality (AR) googles to review notes overlayed on the physical car left by other technicians and/or adjusters in real-time. If a digital event model, or other video, of the product-related event (e.g., vehicle accident) is available, leveraging virtual reality playback will allow the relevant parties to view the accident in 3D space, enabling new views, overlay statistics, and overall better transferring of data involving the product and/or product-related event. Advantageously the integration processes disclosed, including (for instance) the mobile application with LIDAR imaging functionality, the facility digital twin environment, and the use of extended reality technologies, enhance product-related processing, and allow for multiple stakeholders to collaboratively review and analyze product-related data in real-time. The use of extended reality technology for, for instance, playback of a product-related event, allows for a more comprehensive understanding of the event, which can greatly aid in one or more processes related to the event.

As one example only, the product can be a vehicle, and the event a vehicle accident, where the integration process facilitates communication processing between stakeholders, including the vehicle owner or user, a repair technician and a claim agent. In such a case, after a vehicle accident, the user scans the damaged vehicle using the mobile device's LIDAR imaging facility to generate LIDAR point cloud data, which can then be uploaded (either directly or in the form of a 3D model) to one or more remote computer resources, such as a computer resource hosting the generated facility digital twin, and/or to one or more other computer resources of one or more stakeholders. As noted, the LIDAR point cloud data is used (for instance, by the mobile device) to render a 3D digital product-related model which can then be uploaded to, or linked with, the facility digital twin in the metaverse. In one or more embodiments, extended reality technology, such as virtual reality, or a web-based application, can be used to review the uploaded data. Multiple parties can collaborate in real-time within the facility digital twin by leaving, for instance, message data within the facility digital twin, with the message data being associated with, or linked to, the digital product-related model and/or digital event model (e.g., generated from data obtained related to the vehicle accident). For instance, if digital video footage of the product-related event is available, the video data can be sent to the central computer resource for generating the digital 3D event model of the vehicle accident. In this way, the event can be played back virtually, for instance, leveraging virtual reality technology, with the created 3D digital event model being associated with the facility digital twin and allowing the parties to view the event from different points, and help identify issues. To assist with recreating a vehicle-related event using extended reality technology, as much available data as possible can be gathered, including video footage, any reports or statements regarding the event, and any other relevant information. This digital data is then used to create the digital model of the product-related event (e.g., vehicle accident scene and the vehicles involved). In one or more embodiments, investigators can use virtual reality, augmented reality, and/or mixed reality technology to immerse themselves in the digital model and experience the event through the model. This can include using virtual reality headsets, augmented reality glasses, or mixed reality devices that allow the user to see the digital model overlayed, for instance, on the real world. Using extended reality playback, one or more investigators can explore a vehicle accident scene from different angles, pause or rewind the events, and manipulate the data model to better understand the event.

In another embodiment, a manufacture wishes to monitor and optimize a production line in order to minimize down time. In this embodiment, sensors (such as LIDAR sensors) are installed throughout the production line to collection data on each stage of a product manufacturing process. The sensors can be connected to a central hub that aggregates the data and sends it to a computer resource implementing an integration process, such as described herein. In one or more embodiments, the central computer resource can be a cloud-based computer resource. Using one or more trained machine learning algorithms, the collected data is analyzed to identify patterns and anomalies that can indicate potential issues or opportunities for improvement. One or more clustering algorithms can be used to group similar data points together. In the context of production line optimization, clustering can be used to identify groups of machines or processes that behave similarly, and to identify patterns or anomalies in their behavior. Based on insights from the data analysis, the manufacturer can implement changes to the production line, such as adjusting the timing of certain processes, changing the order in which tasks are performed, updating equipment, etc. To monitor effectiveness of changes, the manufacturer can continue to collect data and analyze the production line using the collected data. If changes result in improvements, the changes are maintained, and if not, the manufacturer can reevaluate and make additional adjustments as needed. To provide real-time visibility into the status of the production line, the integration process generates a digital twin of the production line that can be viewed in a virtual environment. The digital twin is updated in real-time with data from the sensors, and allows one or more operations to monitor the production line and identify any issues as they arise. To further optimize the process, virtual reality and/or augmented reality technology can be used to simulate different scenarios and test the impact of various changes on the production line. For example, the addition of a new machine or the hiring of additional operators can be simulated within the facility digital twin to see how overall efficiency of the line is affected. By using the digital technologies, the company is able to continuously monitor, and optimize its production line, reducing downtime, improving quality, and increasing output.

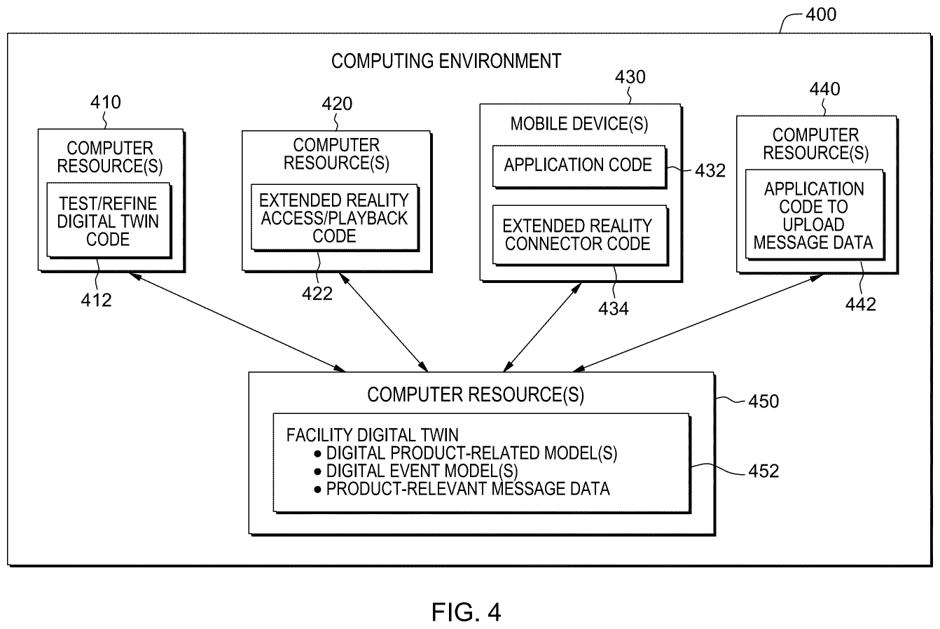

By way of further example, FIG. 4 depicts another embodiment of a computing environment 400 to include and/or use one or more aspects of the present disclosure. In one or more embodiments, computing environment 400 is implemented as part of, or includes, a computing environment such as computing environment 100 described above in connection with FIG. 1A, and/or computing environment 100′ described above in connection with FIG. 1B. Computing environment 400 contains one or more computer resources 410, 420, 430, 440 & 450, such as one or more computers 101 of FIG. 1A and/or one or more mobile devices such as discussed with reference to FIG. 1B.

In the embodiment of FIG. 4, computer resource(s) 450 of computing environment 400 is shown to include a generated facility digital twin 452, which has linked thereto one or more of a digital product-related model(s), a digital event model(s) and product-relevant message data. As illustrated, a variety of computer resources and/or mobile devices can operatively couple to computer resource(s) 450, and in particular, to facility digital twin 452 to implement various aspects described herein. For instance, computer resource(s) 410 can include one or more codes for testing and/or refining the facility digital twin 412 and associated processes, including, for instance, connection to the facility digital twin and other functionality described herein associated with the digital twin. Computer resource(s) 420 can include, in one or more embodiments, extended reality access or playback code or module 422 to allow a user to access the facility digital twin 452, and view via extended reality one or more of the product-related models, digital event models, and/or product relevant message data. One or more mobile devices 430, such as mobile device 162 of FIG. 1B, can include application code 432, such as application code 173 described above in connection with FIG. 1B to facilitate integration processing such as described herein. Further, in one or more embodiments, mobile device(s) 430 can include extended reality connector code 434, such as extended reality connector code 176 of FIG. 1B to allow a user of the mobile device to access the facility digital twin, including the linked digital product-related model(s), digital event model(s) and/or product relevant message data 452. Computer resource(s) 440 can include, for instance, application code to upload message data 442 to facility digital twin 452, where the message data is related to the product and/or product-related event.

Referring to FIGS. 1B & 4, in one or more embodiments, the mobile device(s) application code includes an interface that allows the application code to interact with the LIDAR imaging sensors provided with the mobile device. For instance, in one or more embodiments, the application code can be configured to access the mobile device's built-in LIDAR facility, such as to capture depth information, create point clouds, instruct 3D renderings of objects, etc. Further, the application code is configured, in one or more embodiments, with a user guide or interactive tutorial that provides detailed, step-by-step instructions on how to perform a LIDAR scan of a product, such as a damaged vehicle. The guide includes, in one embodiment, visual aids, clear descriptions, and suggestions for best practices, such as optimal scanning distance and scanning angles to ensure a comprehensive scan. In addition, with capturing the LIDAR point cloud data, the application code is configured with a feature to process the data in real-time to produce a 3D model rendering of the damaged vehicle. This can involve converting the raw point cloud data into a 3D mesh, applying texture mapping and realistic visualization, and displaying the rendering with the application interface.

In one or more embodiments, the mobile application includes a secure and efficient data upload feature to transfer 3D renderings, such as the digital product-related model to the centralized server. In one or more embodiments, edge-based processing can be used, with the 3D data being compressed to minimize upload times and data usage costs. In one or more embodiments, the application can further include error checking mechanisms to ensure successful upload, and encryption of transferred data for secure data transfer. In one or more embodiments, the mobile device includes a connection facility to ensure secure connection to the facility digital twin. In one or more embodiments, the 3D digital product-related model(s) is transferred to the metaverse via a secure API connection. In one or more embodiments, the uploaded model becomes accessible via the facility digital twin, such as the digital twin of the vehicle repair shop, in one example. In one or more embodiments, the integration process and code, including the application, implements secure protocols to insure proper encryption decryption of data for secure data transfer between the device and computer resource. In one or more embodiments, the application code includes a communication module that allows feedback and annotations made, for instance, by technicians and/or agents in the metaverse to be pushed to the user's mobile device. In one or more embodiments, a notification system or alert system is used to alert the user of updates or new messages, allowing the user to further respond or add additional annotations, if needed.

To assist with the integrated process, such as with damage assessment, and streamline a claims process, one or more machine learning algorithms, such as one or more convolution neural networks (CNN), can be used to, for instance, recognize various parts of a vehicle and detect damage based on the LIDAR point cloud data and/or the generated LIDAR-based 3D model (i.e., digital product-related model). Note that training the machine learning algorithms or models can be performed using a large dataset of 3D vehicle models, and varying levels of types of damage, in one embodiment. Further, in one or more embodiments, the integration process generates, builds and manages a robust local and cloud-based knowledge corpus that supports the capture protocols, the storage reference and the associated operations described. In one or more embodiments, one or more application programing interfaces (APIs) are used, including APIs to bridge communication between the mobile device application and the facility digital twin in the metaverse. For instance, a RESTful API can be used to send and receive HTTP requests for data transfer, and a WebSocket API can provide a persistent connection for real-time updates in two-way communication. In one or more embodiments, the integration process adheres to established IT security standards, such as SSL/TLS for secure data transfer. Products are available for API authorization to provide secure access control to the facility digital twin environment.

In one or more embodiments, a variety of platforms for enhanced augmented reality experiences can be utilized to offer various capabilities that enhanced augmented reality experiences, such as environmental understanding, motion tracking, and light estimation. They can be utilized for the AR features of the application, providing a realistic and interactive visualization of a damaged vehicle, with overlayed annotations. In one or more embodiments, game development platforms can be used to provide extensive support for creating and managing 3D environments. They offer robust capabilities for virtual reality/augmented reality integration, real-time 3D rendering, and multi-platform deployment, making them suitable for deploying the facility digital twin in the metaverse, such as described herein.

In one or more embodiments, various available libraries for machine learning can be used. These libraries offer comprehensive tools for developing and training machine learning modules, such as the machine learning models described herein. For instance, in one or more embodiments, the tools can be used to implement the machine learning algorithms required for automatic damage recognition, such as described.

In embodiments, disclosed herein are computer-implemented methods, computer program products, and computer systems which include, or implement, integrated processing (as described) where LIDAR technology, digital twin and metaverse technology and extended reality technology are integrated in a single process to, for instance, facilitate processing related to a product, such as a vehicle, and/or an event, such as vehicle accident. In one or more embodiments, a facility digital twin is generated in the metaverse, such as for a vehicle repair shop. This involves generating a realistic 3D model of one or more aspects of the facility, including, in one or more embodiments, the layout, tools, and/or machinery. The model is then used as the virtual environment for assessment and processing of vehicle damage (in one embodiment). Further, the integrated processing described herein links the facility digital twin with the described mobile application to provide a system where a 3D product model is generated based on LIDAR point cloud data, which can then be uploaded to the metaverse and viewed in association with the facility digital twin. In one or more embodiments, virtual reality and/or augmented reality functionality is integrated with the process to, for instance, allow technicians, adjusters, etc., to view and interact with the facility digital twin, and in particular, the digital product-related model(s) and/or digital event model(s), as desired. In one or more embodiments, the integration process allows multiple users to interact with one or more of the 3D models simultaneously and leave notes, make annotations, and collaborate in real-time in the metaverse. In one or more embodiments, an extended reality playback feature is included as part of the integrated process by generating a digital 3D event model(s) of the event, such as a vehicle accident, to allow a virtual playback of the event in the metaverse derived from available data including, for instance, any video footage, LIDAR scans, etc. In one or more embodiments, the extended reality and facility digital twin integration is tested to ensure components work together seamlessly, and any issues are addressed by refining the integrated system, such as based on user feedback.

In embodiments, systems and development engines are commercially available to provide the resources to assist with generating a facility digital twin, such as described herein, and to support virtual reality and/or augment reality integration, as well as offering robust tools for 3D modeling and rendering, such as described. Further, one or more web browsers and mobile applications are available to allow for real-time communication capabilities via a simple application programing interface, which can be used to implement the real-time collaboration code features within the facility digital twin described. In one or more embodiments, existing advanced augmented reality capabilities can be used in association with the facility digital twin generated within the metaverse, and the application functionality described herein implemented on the user's mobile devices. These capabilities can be used to implement the augmented reality functionalities disclosed for the integrated process, such as viewing the 3D model of the damaged vehicle overlay on the physical vehicle, with real-time annotations provided in association with the 3D model. A variety of 3D graphic rendering products are available to facilitate the 3D graphic requirements of the facility digital twin, and the 3D models described herein. As noted, in one or more embodiments, machine learning models can be trained to assist with recreating an event, such as a vehicle accident, in three dimensions, and re-enforcement learning algorithms can be trained to learn from the available data to generate a realistic digital event model of the event. A variety of application programing interfaces are available for use in storing and retrieving 3D models and other data, such as described.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Although various embodiments are described above, these are only examples. For example, other models and/or weather data may be used. Moreover, additional, less and/or other code may be used. Although particular code may be provided as an example of performing a particular operation or task, additional and/or other code may be used. Code may be combined and/or separated into code subsets. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
generating, by a computing device, a facility digital twin of a product facility that can be accessed in a virtual environment;
obtaining, by the computing device based on data-analytics processing of product-related LIDAR data, a digital product-related model; and
linking, by the computing device, the digital product-related model to the facility digital twin for access via the facility digital twin.

2. The computer-implemented method of claim 1, wherein the product-related LIDAR data comprises vehicle-related LIDAR data and the digital product-related model comprises a digital 3D vehicle-related model.

3. The computer-implemented method of claim 2, wherein the obtaining comprises obtaining, by the computing device, the digital product-related model across a network from a user mobile device.

4. The computer-implemented method of claim 2, wherein the generating comprises generating, by the computing device, the facility digital twin model for access via the metaverse.

5. The computer-implemented method of claim 1, further comprising:
receiving by the computing device, product-related event data on a product-related event;
generating, based on the product-related event data, a digital event model of the product-related event; and
linking, by the computing device, the digital event model to the facility digital twin for access via the facility digital twin.

6. The computer-implemented method of claim 5, wherein generating the digital event model of the product-related event comprises generating the digital event model for playback via the facility digital twin using one or more extended reality technologies.

7. The computer-implemented method of claim 6, wherein the product-related event data comprises vehicle-related video data and the product-related event comprises a vehicle accident.

8. The computer-implemented method of claim 1, further comprising receiving, by the computing device, product-relevant message data from one or more other computing devices and linking, by the computing device, the product-relevant message data to the facility digital twin for access via the facility digital twin.

9. The computer-implemented method of claim 8, further comprising transmitting, by the computing device, the product-relevant message data to a user mobile device in real-time based on the receiving of the product-relevant message data at the computing device.

10. A computer program product comprising:
a set of one or more computer-readable storage media; and
program instructions, collectively stored in the set of one or more computer-readable storage media, for causing at least one computing device to perform computer operations including:
generating a facility digital twin of a product facility that can be accessed in a virtual environment;
obtaining, based on data-analytics processing of product-related LIDAR data, a digital product-related model; and
linking the digital product-related model to the facility digital twin for access via the facility digital twin.

11. The computer program product of claim 10, wherein the product-related LIDAR data comprises vehicle-related LIDAR data and the digital product-related model comprises a digital 3D vehicle-related model, and wherein the obtaining comprises obtaining the digital product-related model across a network from a user mobile device.

12. The computer program product of claim 10, wherein the product-related LIDAR data comprises vehicle-related LIDAR data and the digital product-related model comprises a 3D vehicle-related model, and wherein the generating comprises generating the facility digital twin model for access via the metaverse.

13. The computer program product of claim 10, further comprising:
receiving product-related event data on a product-related event;
generating, based on the product-related event data, a digital event model of the product-related event; and
linking the generated digital event model to the facility digital twin for access via the facility digital twin.

14. The computer program product of claim 13, wherein generating the digital event model of the product-related event comprises generating the digital event model for playback via the facility digital twin using one or more extended reality technologies.

15. The computer program product of claim 14, wherein the product-related event data comprises vehicle-related video data and the product-related event comprises a vehicle accident.

16. The computer program product of claim 10, further comprising receiving product-relevant message data from one or more other computing devices and linking the product-relevant message data to the facility digital twin for access via the facility digital twin.

17. A computer system comprising:
at least one computing device;
a set of one or more computer-readable storage media; and
program instructions, collective stored in the set of one or more computer-readable media, for causing the at least one computing device to perform computer operations including:
generating a facility digital twin of a product facility that can be accessed in a virtual environment;
obtaining, based on data-analytics processing of product-related LIDAR data, a digital product-related model; and
linking the digital product-related model to the facility digital twin for access via the facility digital twin.

18. The computer system of claim 17, wherein the product-related LIDAR data comprises vehicle-related LIDAR data and the digital product-related model comprises a digital 3D vehicle-related model, and wherein the obtaining comprises obtaining the digital product-related model across a network from a user mobile device.

19. The computer system of claim 17, wherein the product-related LIDAR data comprises vehicle-related LIDAR data and the digital product-related model comprises a 3D vehicle-related model, and wherein the generating comprises generating the facility digital twin model for access via the metaverse.

20. The computer system of claim 17, further comprising:
receiving product-related event data on a product-related event;
generating, based on the product-related event data, a digital event model of the product-related event; and
linking the generated digital event model to the facility digital twin for access via the facility digital twin.
